(19) United States
(12) Patent Application Publication
(10) Pub. No.: US 2013/0226658 A1
(43) Pub. Date: Aug. 29, 2013

(54) CONTENT ANALYZING SYSTEM, CONTENT ANALYZING APPARATUS, CONTENT ANALYZING METHOD, AND CONTENT ANALYZING PROGRAM

(71) Applicants: Chihiro Ito, Tokyo (JP); Takashi Shiraki, Tokyo (JP)

(72) Inventors: Chihiro Ito, Tokyo (JP); Takashi Shiraki, Tokyo (JP)

(73) Assignee: NEC CORPORATION, Tokyo (JP)

(21) Appl. No.: 13/883,440

(22) PCT Filed: Nov. 17, 2011
(86) PCT No.: PCT/JP2011/076562

§ 371 Date: May 3, 2013

(30) Foreign Application Priority Data
Nov. 29, 2010 (JP) 2010-264735

(51) Int. Cl. G06Q 30/02

(52) U.S. Cl. CPC G06Q 30/0201
USPC 705/7.29

(57) ABSTRACT

A contents analysis system comprises a user terminal, and a contents analysis device which receives a predetermined request from the user terminal and returns a result, wherein the contents analysis device comprises a propagation pattern extraction unit which extracts a pattern of propagation indicating, with respect to each of contents included in history data formed of histories of use of a plurality of contents, how the content propagated to a user, and a correlation calculation unit which obtains a correlation between the patterns of propagation of the contents.

### TECHNICAL FIELD

The present invention relates to contents analysis techniques and, more particularly, a contents analysis system, a contents analysis device, a contents analysis method and a contents analysis program which find a correlation between arbitrary content and other contents in a pattern of propagation to users.

### BACKGROUND ART

Correlation analysis is an analysis method of describing a relationship between two variables in numerical values and is used for information recommendation or marketing.

In information recommendation, for example, an algorithm called collaborative filtering is well known as a recommendation method of recommending content whose similarity or relevance is high by obtaining a correlation between contents or users from a history of use or rating of content by a user.

In recent years, gaining more importance are recommend systems which automatically grasp contents interesting users among numerous contents (electronic books, news, moving images, music etc.) and present them to the users, which systems provide service of recommending highly relevant contents by such an advertising phrase as “One who bought this product also bought such a product” in a shopping mall or the like.

Related art about collaborative filtering which makes the use of correlation for information recommendation is recited, for example, in Non-Patent Literature 1, Patent Literature 1 and Patent Literature 2.

Non-Patent Literature 1 is a paper describing an algorithm for the earliest fundamental basic collaborative filtering.

Patent Literature 1 relates to a recommendation technique having an effect of reducing work of managing location information including addition of URL by using individually registered location information (such as a bookmark) of each user to recommend location information from a category whose relevance is high on a category basis.

Patent Literature 2 relates to collaborative filtering having the effect of preventing recommending a beginner an item for an experienced person by grouping users into a plurality of groups based on access histories, assigning the users to the plurality of groups and extracting a transition whose frequency is high by using a time-series access history to set up recommendation rules.

These techniques aim at obtaining correlations between contents, between users and between categories to appropriately recommend content whose similarity and relevance are both high in correlation.

These techniques, however, only obtain a correlation between frequencies of contents use or rating.

While Patent Literature 2 uses a frequency of a frequency pattern of time-series transition, it only uses frequencies of transition patterns as of before and after a transition from content 1 to content 2 and fails to take into consideration of similarity of user propagation as to how the contents propagated to users. It is therefore impossible to recommend contents at propagation timing appropriate for the users.

Patent Literature 1: Patent No. 4118580

Patent Literature 2: Japanese Patent Laying-Open No. 2008-176398

Patent Literature 3: Japanese Patent Laying-Open No. 2004-3662208

Patent Literature 4: Japanese Patent Laying-Open No. 2010-140162

Non-Patent Literature 1: P. Resnick, N. Iacovou, M. Suchak, P. Bergstrom, and J. Riedl, “GroupLens: Open Architecture for Collaborative Filtering of Netnews”, Conference on Computer Supported Cooperative Work, p. 175-186, 1994.

The problem of the above-described related art is failing to find a characteristic, that is, a correlation between propagation patterns of contents to users to make the best use of it for such an applied field as information recommendation or marketing analysis.

In information recommendation, for example, since contents whose propagation patterns are different are handled equally, recommendation of contents at propagation timing appropriate for a user is impossible.

The reason is that when obtaining a correlation as a characteristic between contents, the correlation is obtained only by using a frequency of use (rating) of the contents by a user and not considering a correlation between propagation patterns indicating how the contents propagated to the user.

### OBJECT OF THE INVENTION

An object of the present invention is to provide a contents analysis system, a contents analysis device, a contents analysis method and a contents analysis program which solve the above-described problems and enable a correlation between propagation patterns of contents to users, the correlation as a characteristic to be found which can be made use of for information recommendation or marketing analysis and in information recommendation, for example, enable contents to be recommended at appropriate propagation timing.

### SUMMARY

According to a exemplary aspect of the invention, a contents analysis system comprises

a user terminal, and

a contents analysis device which receives a predetermined request from the user terminal and returns a result,

wherein the contents analysis device comprises

a propagation pattern extraction unit which extracts a pattern of propagation indicating, with respect to each of contents included in history data formed of histories of use of a plurality of contents, how the content propagated to a user, and

a correlation calculation unit which obtains a correlation between the patterns of propagation of the contents.

According to a exemplary aspect of the invention, a contents analysis device which receives a predetermined request from a user terminal and returns a result comprises

a propagation pattern extraction unit which extracts a pattern of propagation indicating, with respect to each of contents included in history data formed of histories of use of a plurality of contents, how the content propagated to a user, and

a correlation calculation unit which obtains a correlation between the patterns of propagation of the contents.

According to a exemplary aspect of the invention, a contents analysis method of a contents analysis device which receives a predetermined request from a user terminal and returns a result according to a exemplary aspect of the invention, comprises

a propagation pattern extraction step of extracting a pattern of propagation indicating, with respect to each of contents included in history data formed of histories of use of a plurality of contents, how the content propagated to a user, and

a correlation calculation step of obtaining a correlation between the patterns of propagation of the contents.

According to a exemplary aspect of the invention, a contents analysis program operable on a computer functioning as a contents analysis device which receives a predetermined request from a user terminal and returns a result, which causes the computer to execute

a propagation pattern extraction processing of extracting a pattern of propagation indicating, with respect to each of contents included in history data formed of histories of use of a plurality of contents, how the content propagated to a user, and

a correlation calculation processing of obtaining a correlation between the patterns of propagation of the contents.

The present invention enables a correlation between propagation patterns of contents to users as a characteristic to be found which can be made use of for information recommendation or marketing analysis and enables contents to be recommended at appropriate propagation timing in information recommendation, for example.

Other objects, features and advantages of the present invention will become clear from the detailed description given herebelow.

### BRIEF DESCRIPTION OF THE DRAWINGS

In the drawings:

FIG. 1 is a block diagram showing a structure of a first exemplary embodiment of the present invention;

FIG. 2 is a diagram showing an illustrative example of history data according to the first exemplary embodiment;

FIG. 3 is a flow chart showing operation of a contents analysis system according to the first exemplary embodiment;

FIG. 4 is a flow chart showing operation of an Example 1 of the present invention;

FIG. 5 is a diagram showing an illustrative example 1 of propagation patterns (order of propagation) extracted in the Example 1;

FIG. 6 is a diagram showing intermediate data for use in calculating a correlation between the propagation patterns of the Example 1 in the illustrative example 1;

FIG. 7 is a diagram showing an illustrative example 2 of propagation patterns (stage of propagation) extracted in the Example 1;

FIG. 8 is a diagram showing intermediate data for use in calculating a correlation between the propagation patterns of the Example 1 in the illustrative example 2;

FIG. 9 is a diagram showing an illustrative example 3 of propagation patterns (network structure for propagation) extracted in the Example 1;

FIG. 10 is a diagram showing intermediate data for use in calculating a correlation between the propagation patterns of the Example 1 in the illustrative example 3;

FIG. 11 is a block diagram showing a structure of a second exemplary embodiment of the present invention;

FIG. 12 is a flow chart showing operation of the second exemplary embodiment;

FIG. 13 is a flow chart showing operation of an Example 2 of the present invention;

FIG. 14 is a diagram showing an illustrative example of propagation patterns extracted in the Example 2;

FIG. 15 is a block diagram showing a structure of a third exemplary embodiment of the present invention;

FIG. 16 is a flow chart showing operation of the third exemplary embodiment;

FIG. 17 is a flow chart showing operation of an Example 3 of the present invention;

FIG. 18 is a diagram showing an illustrative example of propagation patterns extracted in the Example 3; and

FIG. 19 is a block diagram showing an example of hardware configuration of a contents analysis device of the present invention.

### EXEMPLARY EMBODIMENT

The preferred embodiment of the present invention will be discussed hereinafter in detail with reference to the accompanying drawings. In the following description, numerous specific details are set forth in order to provide a thorough understanding of the present invention. It will be obvious, however, to those skilled in the art that the present invention may be practiced without these specific details. In other instance, well-known structures are not shown in detail in order to unnecessary obscure the present invention.

Detailed description will be made of an exemplary embodiment of the present invention with reference to the drawings. In all the drawings, like components are identified by the same reference numerals to appropriately omit description thereof.

### First Exemplary Embodiment

First exemplary embodiment of the present invention will be detailed with reference to the drawings. In the following drawings, description will be appropriately omitted of a structure of a part not related to the gist of the present invention and no illustration will be accordingly made thereof.

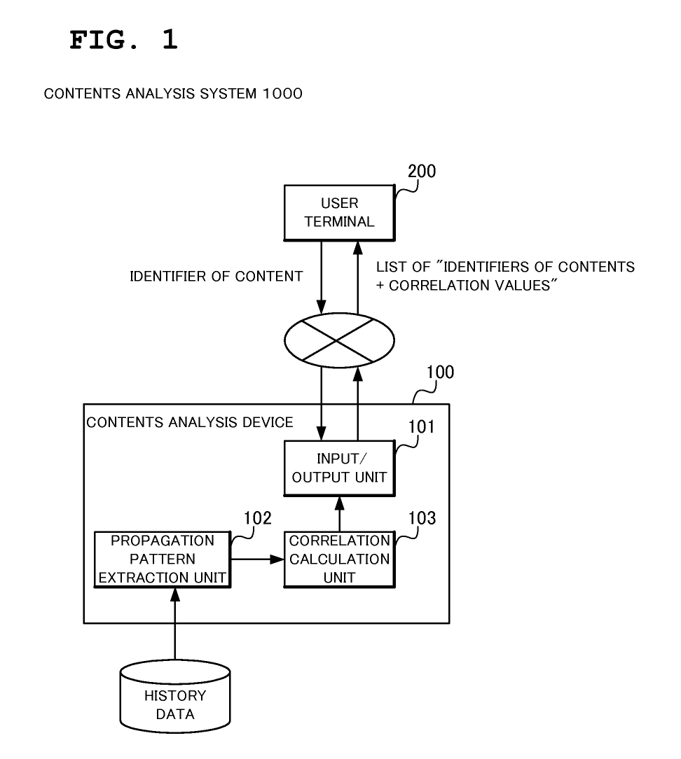

FIG. 1 is a block diagram showing a structure of a contents analysis system 1000 according to the first exemplary embodiment of the present invention. terminal 2/

With reference to FIG. 1, the contents analysis system 1000 according to the present exemplary embodiment is formed by a user terminal 200 and a contents analysis device 100.

The user terminal 200 is a terminal for a user to use contents and the like. The user terminal 200 transmits an identifier of content whose propagation pattern is to be examined to the contents analysis device 100 by using an input/output unit 201 not shown. The terminal 200 also receives an examination result from the contents analysis device 100.

The contents analysis device 100 includes an input/output unit 101 which transmits and receives data to/from the user terminal 200, a propagation pattern extraction unit 102 which extracts a pattern of propagation to users on a contents basis, and a correlation calculation unit 103 which obtains a correlation between patterns of propagation of predetermined contents to the users.

In brief, these units each operate in the following manner.

The input/output unit 101 receives a predetermined request from the user terminal 200 and returns an output corresponding to the request to the user terminal. More specifically, upon accepting an identifier of content from a user, the unit returns a correlation between the content in question and at least one other content, and an identifier of that other content as an output.

In the present exemplary embodiment, upon accepting an identifier of content as an input, the input/output unit 101 returns a correlation between propagation patterns of the content and each of those contents to the users. At this time, an identifier of each of those contents may be returned together.

The propagation pattern extraction unit 102 extracts a pattern of propagation to users with respect to each of the contents included in history data.

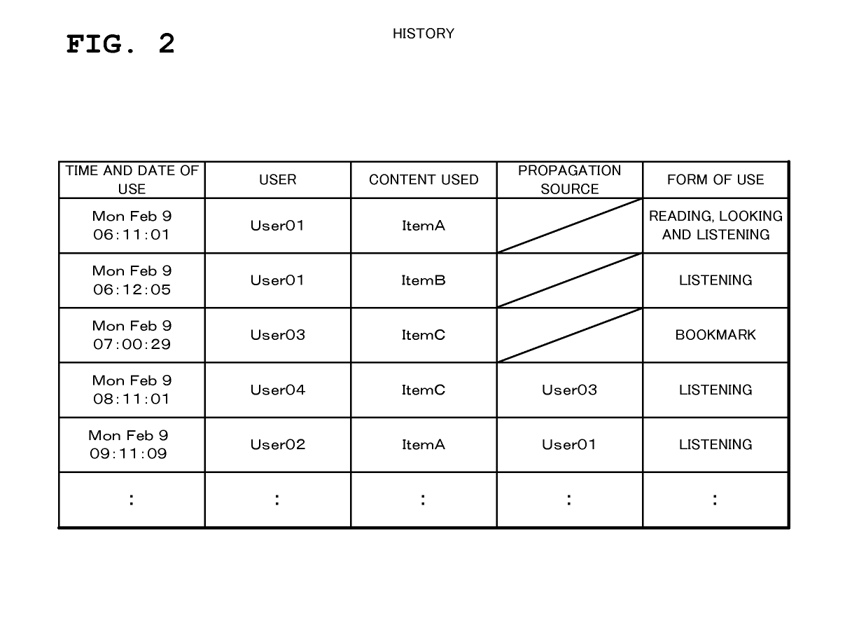

History data represents data indicative of a history of a state of use of each predetermined content. Example of history data is here shown in FIG. 2.

Although history data is premised to be recorded in a predetermined data base, a contents information management server or the like separately provided, the contents analysis device 100 may be provided with a storage unit not limited to such premise. Since a history data storage method itself is not directly related to the present invention, no details and illustration thereof will be made.

Pattern of propagation to users represents a pattern indicating how contents were propagated to the users, which pattern shows an order of propagation, a network structure, a time interval and speed.

Having been propagated denotes that some association or other exists between a user and content, such as use or rating by a user.

The correlation calculation unit 103 calculates a correlation between contents propagations by using a pattern of propagation to users. Only a correlation of patterns of propagation to users may be obtained between content accepted as an input and the other contents.

### Description of Operation of First Exemplary Embodiment

Next, operation of the contents analysis system 1000 according to the present exemplary embodiment will be detailed with reference to the drawings.

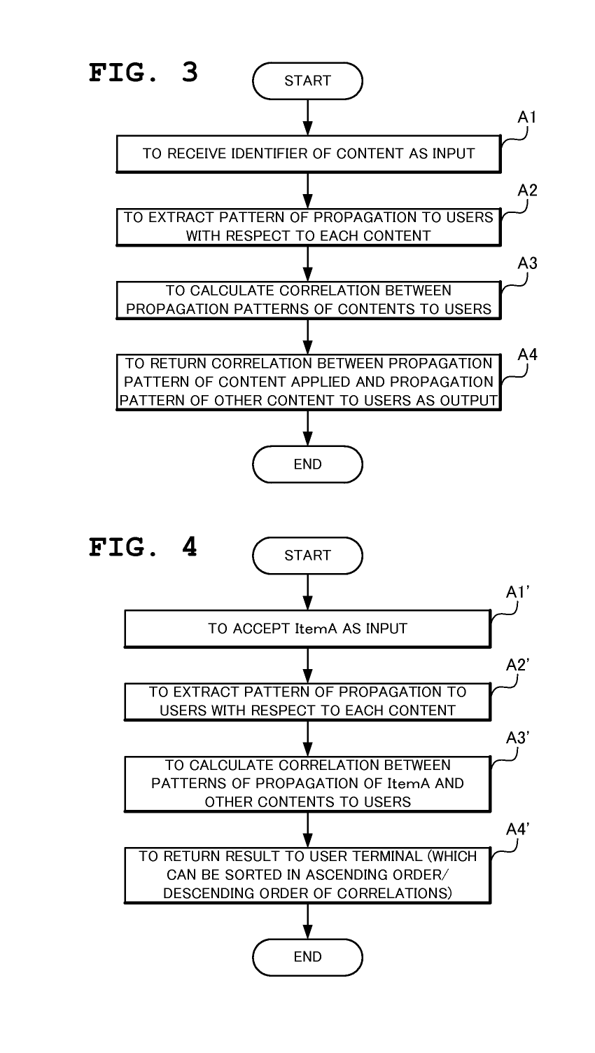

FIG. 3 is a flow chart showing operation of the contents analysis system 1000 according to the present exemplary embodiment.

With reference to FIG. 3, the input/output unit 101 first accepts an identifier of content as an input from the user terminal 200 (Step A1).

Next, the propagation pattern extraction unit 102 obtains history data to extract a pattern of propagation to users with respect to each content included in the history data (Step A2).

Next, the correlation calculation unit 103 obtains a correlation between patterns of propagation of the content accepted as an input and each of those other contents to the users (Step A3).

Next, the input/output unit 101 returns the correlation obtained by the correlation calculation unit 103 together with the identifiers of the contents (Step A4).

At this time, identifiers of the contents may be sorted and returned in descending order of the degree of correlation with the input content.

With a pattern of propagation of each content to users and each correlation between the respective contents calculated and recorded in advance in the calculation unit, upon acceptance of a request from the input/output unit 101, the correlation recorded in the unit may be referred to and returned with identifiers of the contents. This eliminates the processing of Steps A2 and A3 after acceptance of a request.

### FIRST EXAMPLE

Next, operation of the present exemplary embodiment will be described with respect to a specific example.

FIG. 4 is a flow chart showing operation of an Example 1 of the present invention.

With reference to FIG. 4, the input/output unit 101 first accepts Item A (identifier of content indicative of Item A) as an input from the user terminal 200 (Step A1′).

Next, the propagation pattern extraction unit 102 obtains history data to extract a pattern of propagation to users with respect to each content included in the history data (Step A2′). The history data includes at least time and date of use, user and an identifier of content used.

Next, the correlation calculation unit 103 obtains a correlation between patterns of propagation of Item A and each of those other contents to users (Step A3′).

Pattern of propagation to users represents a pattern indicating how content was propagated to users and includes various examples. In the present Example, description will be made of extraction of 1) order of propagation, 2) stage of propagation and 3) network structure for propagation, executed by the propagation pattern extraction unit 102.

In addition to such patterns as described above, possible is a method taking a time interval of propagation between users or speed into consideration.

1) Order of Propagation

Description will be made of a case where as extraction of a pattern of propagation of the contents to users, an order of contents propagation to users is extracted to calculate a correlation between patterns of propagation to users based on the propagation order.

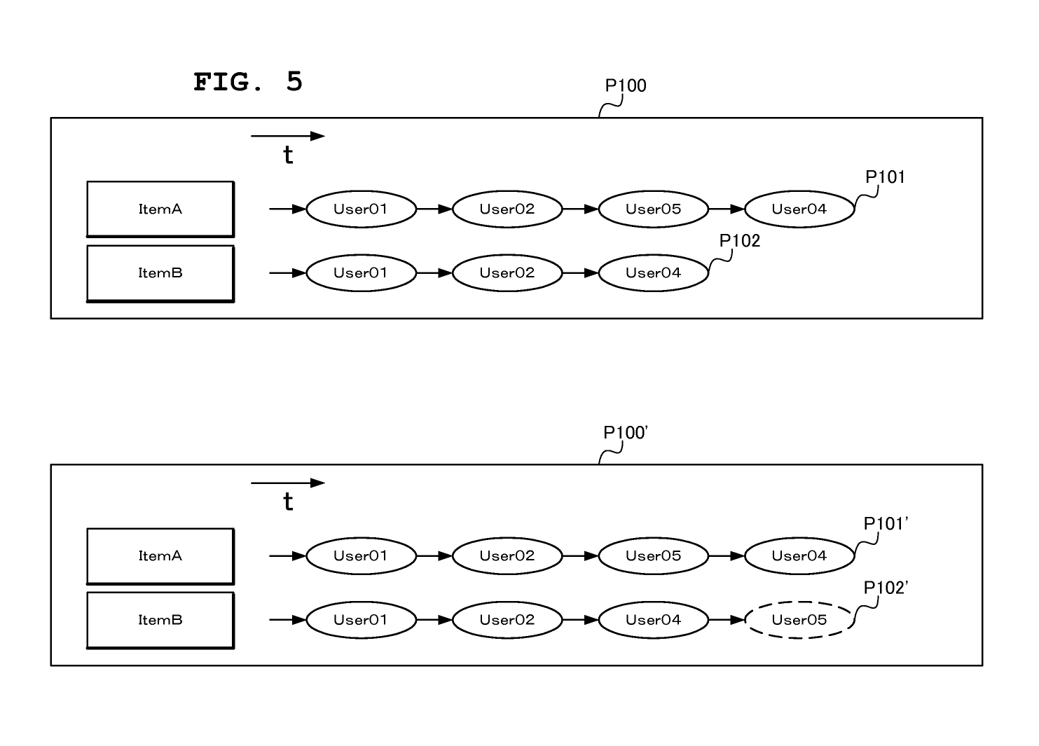

First, with respect to each content included in the history data, the propagation pattern extraction unit 102 extracts the order of propagation to each user as a propagation pattern. Example of a propagation pattern extracted is shown in P100 in FIG. 5.

With reference to P100 in FIG. 5, propagation patterns of Item A and Item B are extracted in the present Example.

Propagation pattern P101 is a propagation pattern of Item A, in which it is seen that Item A is propagated to users in the order of User 01, User 02, User 05 and User 04.

Propagation pattern P102 is a propagation pattern of Item B, in which it is seen that Item B is propagated to users in the order of User 01, User 02, and User 04.

P100′ is obtained by adding a predetermined change to P100 for the calculation of a Spearman's rank correlation coefficient which will be described later.

After the propagation pattern extraction unit 102 extracts a propagation pattern, the correlation calculation unit 103 obtains a correlation between patterns of propagation of the contents to users by using the propagation patterns. Such calculation of a correlation between orders of propagation of the contents to users as described above may be executed by using a correlation coefficient of Spearman, Kendall or the like.

In the present Example, since Item A is accepted as an input, calculate a Spearman's rank correlation coefficient by using, centered on Item A, an order of propagation of Item A and each of those other contents (Item B in the present Example) to users.

With a difference between ranks of two variables denoted as D and the number of cases as N, the Spearman's rank correlation coefficient is given by the following Numerical Expression 1 to take value from 1 to −1.

$$( NUMERICAL EXPRESSION 1 )$$

$${[ \begin{matrix}ρ \text{:} SPEARMAN ' S RANK CORRELATION COEFFICIENT \\ D \text{:} DIFFERENCE BETWEEN RANKS OF TWO VARIABLES \\ N \text{:} THE NUMBER OF CASES\end{matrix} ]}^{ρ = 1 - \frac{{}_{}^{6}{\sum }{}_{}^{D}}{N ( {N}^{2} - 1 )}}$$

The correlation coefficient being positive represents that the two variables have a correlation, conversely being negative represents that they are a negative correlation and being 0 represents a coefficient indicative of a non-correlated state.

Shown in the following is an example of calculation of a correlation between Item A and Item B propagation users by using a Spearman's rank correlation coefficient.

First, in comparison between Item A and Item B propagation users, Item A has User 05, while Item B fails to have User 05.

Thus, when either one has a user to which propagation is yet to be made, calculation will be made assuming that the user to which propagation is yet to be made is a user to which propagation was made last as shown in P101′ in FIG. 5.

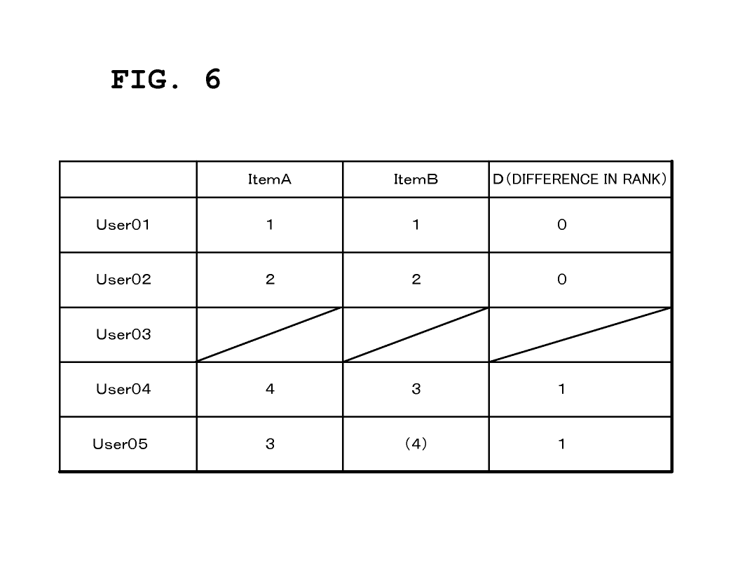

Refer to FIG. 6 here that represents intermediate data for use in calculating a correlation which data is obtained as a difference between the ranks of the respective users with respect to each Item based on P100′ shown in FIG. 5.

FIG. 6 shows the order of propagation to users with respect to each Item (Item A, Item B). The figure also indicates a difference in rank between Item A and Item B on a user basis.

With reference to FIG. 6, Item A propagates in the order of User 01, User 02, User 05 and User 04. Item B propagates in the order of User 01, User 02 and User 04 and is assumed to thereafter propagate to User 05. Difference in the rank of the respective users is an absolute value of the rank difference between Item A and Item B.

Since Item A and Item B each have four users, User 01, User 02, User 04 and User 05, the number N of cases will be obtained as 4.

Substituting the intermediate data shown in FIG. 6 in the calculation expression for a Spearman's rank correlation coefficient results in p(Item A, Item B)=1−6(1+1)/4(16−1)=0.8.

While in the above-described example, the other contents include only Item B, when a plurality of other contents exist, a coefficient of a correlation between Item A and each of those other contents can be calculated in the same manner as that of Item B. Correlation coefficient calculation method is not limited thereto.

### 2) Stages of Propagation

Next, as extraction of a pattern of propagation of contents to users, description will be made of extraction of groups whose propagation stages are the same.

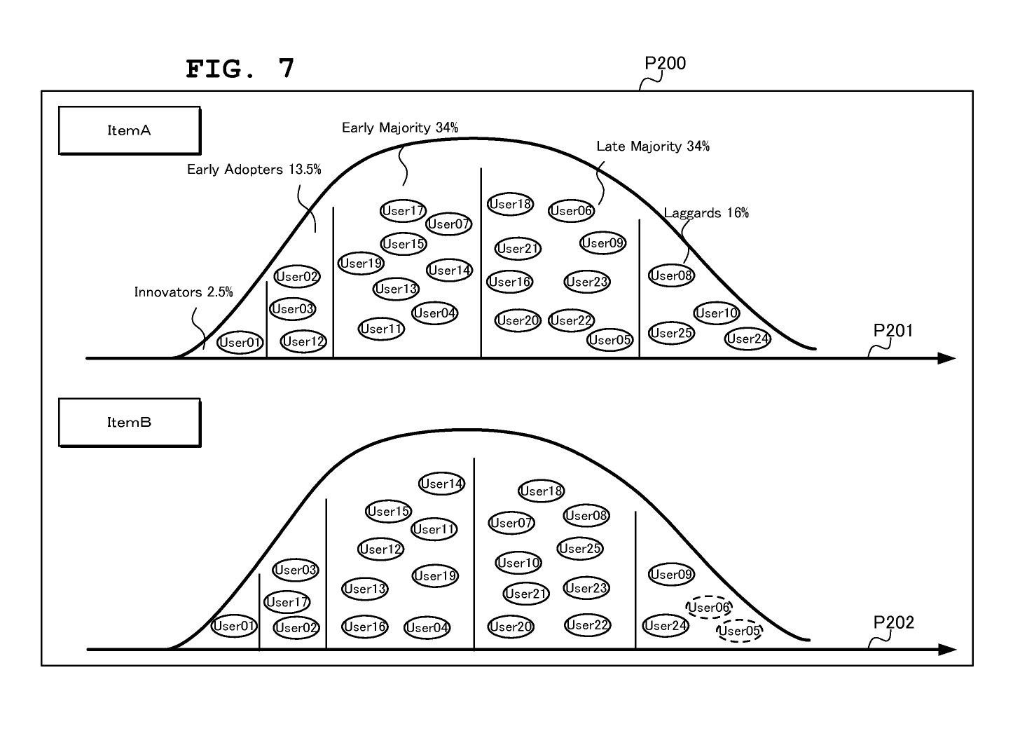

First, with respect to each content included in the history data, the propagation pattern extraction unit 102 divides users to which the content in question propagated into a plurality of groups (stage) based on the Innovator theory. Results of grouping are illustrated in FIG. 7.

The Innovator theory is marketing theory advocated by the processor at Stanford University, Everett M. Rogers, which classifies customers' attitudes toward product purchase into five stages, innovators (2.5%), early adopters (13.5%), early majority (34%), late majority (34%) and laggards (16%) in chronological order of date of purchase of a new product.

In this example, the users are classified into five types of stages in the order of propagation of contents by applying the Innovator theory.

With reference to FIG. 7, P200 represents a propagation pattern obtained by classifying the users to which Item A and Item B propagated according to the Innovator theory.

It is found that P201 has users to which Item A and Item B propagated be grouped into five stages according to the Innovator theory.

In grouping, the number of users of each stage is assumed from the number of all the users by using a proportion of each stage of the Innovator theory.

In the case of FIG. 7, with the number of all the users being 25, assuming from innovators: 2.5%, early adopters: 13.5%, early majority: 34%, late majority: 34% and laggards: 16% that the number of innovators, early adopters, early majority, late majority and laggards are 1, 3, 8, 9 and 4, respectively, assign users to each stage.

Next, the correlation calculation unit 103 obtains a correlation between patterns of propagation of the contents to users by using the number of overlapping users in each stage and its ratio.

When a user to which propagation is yet to be made exists, it is possible to assume propagation to users such as User 06 and User 05 in P202 in order to have a common denominator. Alternatively, a correlation may be obtained by using only a part of stages such as only the innovator.

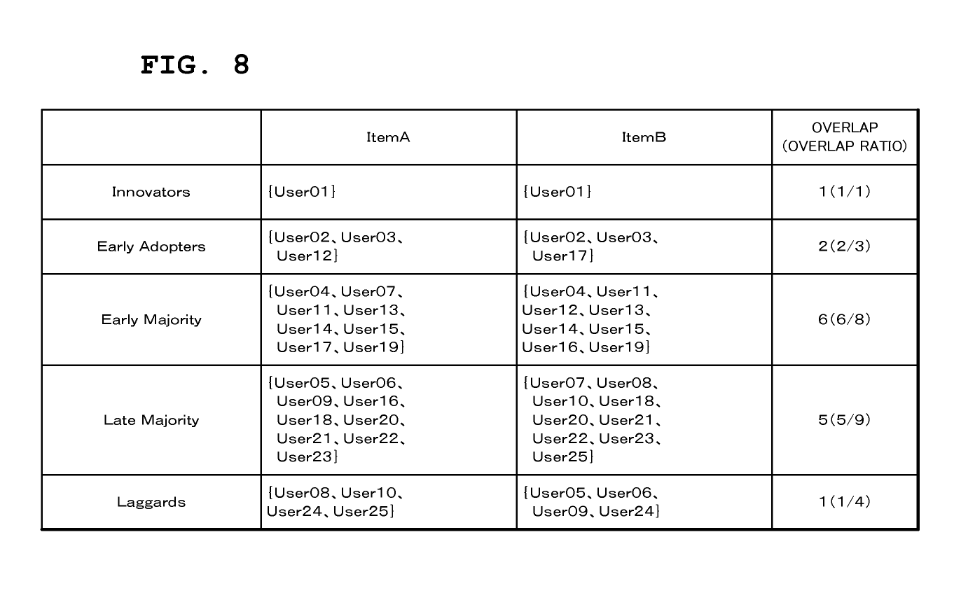

Refer to FIG. 8 here that represents intermediate data for use in calculating a correlation which data is obtained as a ratio of overlapping users in each stage based on FIG. 7.

Obtaining a correlation between patterns of propagation of Item A and Item B to users from a total sum of ratios of overlapping users in the respective groups results in calculation (1+2+6+5+1)/25=0.6 as a coefficient of a correlation between Item A and Item B.

While the above-described example includes only Item B as other contents, when a plurality of other contents exist, a coefficient of a correlation can be calculated also between Item A and each of those other contents similarly to Item B.

While the above-described example uses overlaps of the users in all the stages, a correlation may be obtained using an arbitrary stage, for example, using an overlap of users as innovators. Correlation coefficient calculation method is not limited to the above described method.

3) Network Structure for Propagation

Next, as extraction of a pattern of propagation of contents, description will be made of extraction of a network structure for propagation.

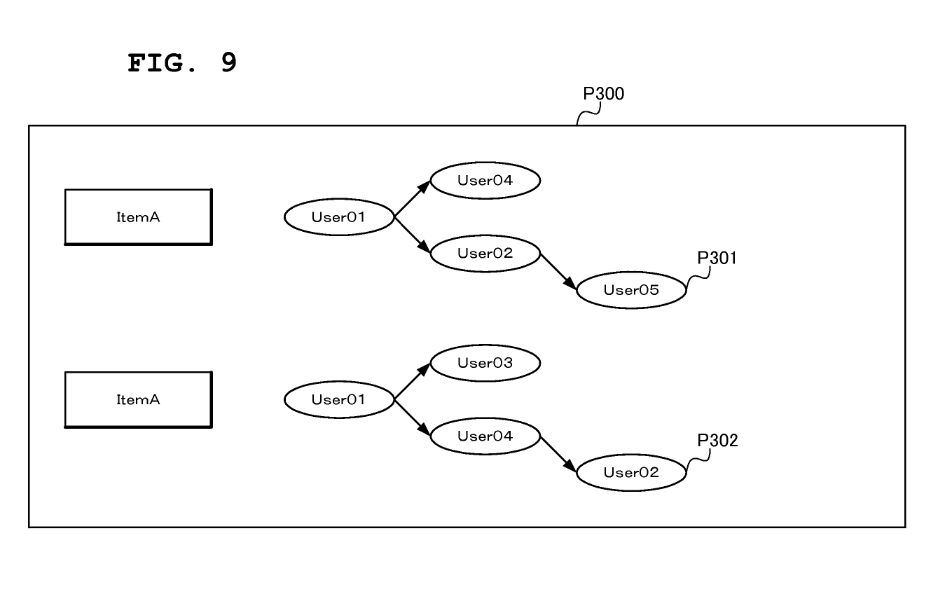

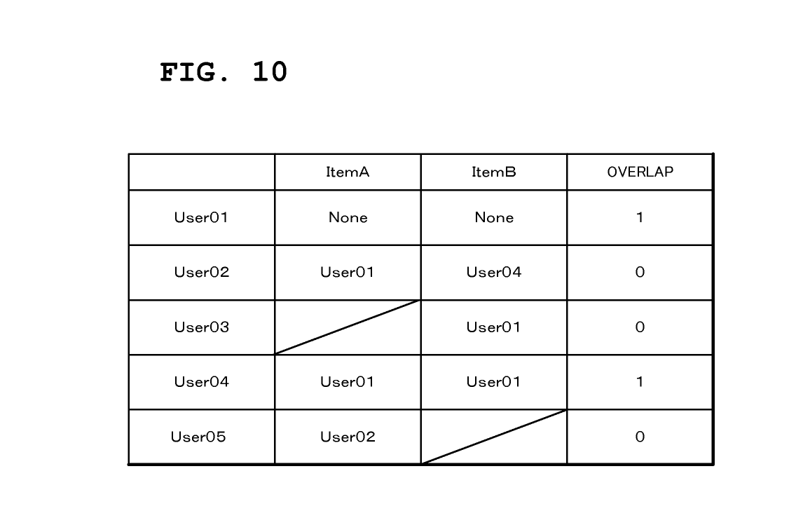

First, extract a network structure for propagation with respect to each content included in history data. In this case, the history data always needs information about a reference source user (transition source user). Result of the extraction is shown in FIG. 9.

Reference source user represents, in a case where a certain user uses predetermined content, for example, when information of other user is correlated with the content, other user in question. Such a situation is assumed to occur in service provided, for example, in a shopping mall, on-line shopping and the like for recommending highly related contents by such an advertising phrase as “person who bought this product also has bought such a product”.

With reference to FIG. 9, P301 represents a network structure for propagation of Item A and P302 represents a network structure for propagation of Item B.

In this network structure, from the view point of an overlap between transition source users as parent nodes of each user as a characteristic, transition relationships of Item A and Item B are as shown in FIG. 10.

With reference to FIG. 9, since the propagation comes first to User 01 in both Item A and Item B, a transition source user of User 01 will be “None” in FIG. 10. This also applies to all the other users and the result will be as shown in FIG. 10.

Then, compare transition source users of Item A and Item B on a user basis to assume an overlap to be 1 when the transition source users are the same and to be 0 when they are different.

Coefficient of a correlation between Item A and Item B can be calculated as ⅖ by taking an overlap ratio.

While the above-described example includes only Item B as other contents, when a plurality of other contents exist, a coefficient of a correlation can be calculated also between Item A and each of those other contents similarly to Item B.

When a correlation between patterns of propagation of Item A and Item B to users is obtained by the above-described 1) to 3), the input/output unit 101 last returns a correlation between Item B accepted as an input and each of other contents to the user terminal 200 together with an identifier of each of those other contents (Step A4′).

Thus, such a characteristic useful for information recommendation, marketing analysis, or the like can be found as a correlation between patterns of propagation of the contents to users.

### Effects of the First Exemplary Embodiment

Next, effects of the present exemplary embodiment will be described. Since according to the present exemplary embodiment, the system is structured to obtain a correlation between patterns of propagation to users by using a pattern of propagation of each content to users, it is possible to find a content whose user propagation pattern is highly correlated with an arbitrary content and make use of the same for information recommendation, marketing analysis or the like.

Even a minimum structure including the propagation pattern extraction unit 102 and the correlation calculation unit 103 can attain the object of the present invention.

### Second Exemplary Embodiment

Second exemplary embodiment of the present invention will be detailed with reference to the drawings. In the following drawings, no description will be made of a structure of a part not related to the gist of the present invention and no illustration will be accordingly made thereof.

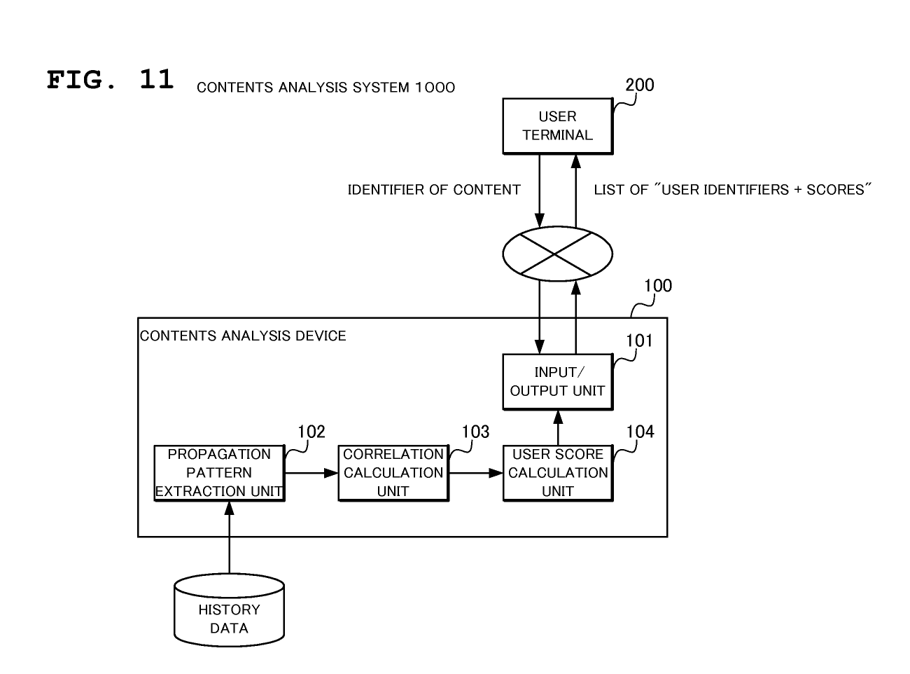

FIG. 11 is a block diagram showing a structure of the contents analysis system 1000 according to the present exemplary embodiment.

With reference to FIG. 11, the contents analysis system 1000 according to the present exemplary embodiment is formed by the input/output unit 101, the propagation pattern extraction unit 102, the correlation calculation unit 103 and a user score calculation unit 104. The present exemplary embodiment includes the user score calculation unit 104 in addition to the components of the first exemplary embodiment.

In brief, these units each operate in the following manner.

The input/output unit 101 receives a predetermined request from the user terminal 200 and returns an output corresponding to the request to the user terminal. In the present exemplary embodiment, upon accepting an identifier of content as an input, the unit returns a score of each user with respect to the content in question together with an identifier of the user as an output.

The propagation pattern extraction unit 102 extracts a pattern of propagation to users with respect to each of the contents from history data similarly to the first exemplary embodiment.

The correlation calculation unit 103 obtains a correlation between patterns of propagation of contents to users similarly to the first exemplary embodiment.

The user score calculation unit 104 calculates a score of each user with respect to each content from a pattern of propagation of each content to users and a correlation between patterns of propagation of the respective contents to users. Only a score of each user with respect to the content accepted as an input may be obtained.

### Description of Operation of the Second Exemplary Embodiment

Next, operation of the contents analysis system 1000 according to the second exemplary embodiment of the present invention will be detailed with reference to the drawings.

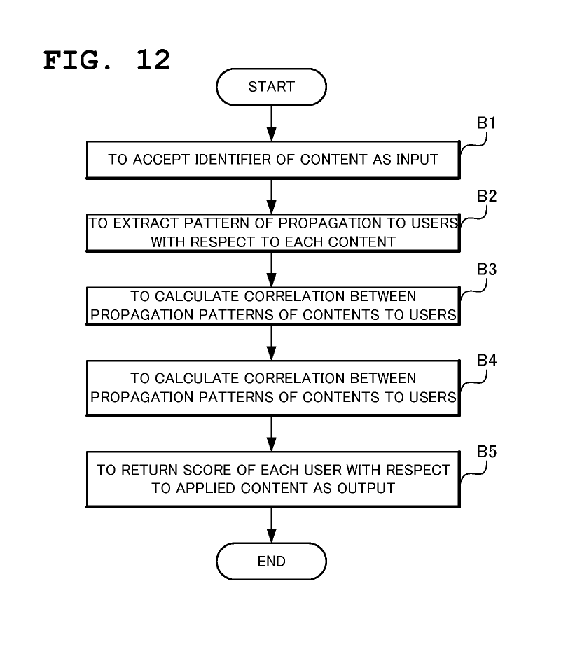

FIG. 12 is a flow chart showing operation of the contents analysis system 1000 according to the present exemplary embodiment.

With reference to FIG. 12, since Steps B1 to B3 are the same as Steps A1 to A3 of the first exemplary embodiment shown in FIG. 3, no description will be here made of Steps B1 to B3.

After Step B3, the user score calculation unit 104 subsequently calculates a score of each user for content accepted as an input by using a correlation between propagation patterns of the content accepted as an input and each of other contents to the users (Step B4). Details of the calculation method will be described in Example 2 to follow.

Then, the input/output unit 101 lastly returns the score of each user with respect to the content accepted as an input to the user terminal 200 together with an identifier of the user (Step B5).

### SECOND EXAMPLE

Next, operation of the present exemplary embodiment will be described with respect to a specific example.

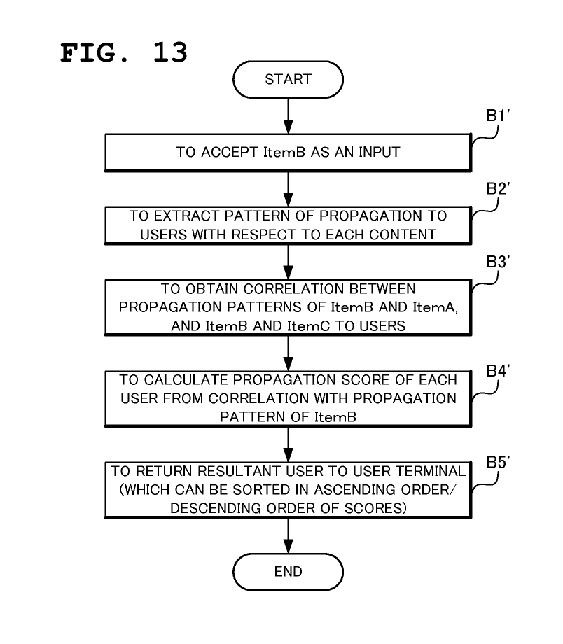

FIG. 13 is a flow chart showing operation of an Example 2 of the present invention.

With reference to FIG. 13, the input/output unit 101 first accepts Item B (identifier of content indicative of Item B) as an input from the user terminal 200 (Step B1′).

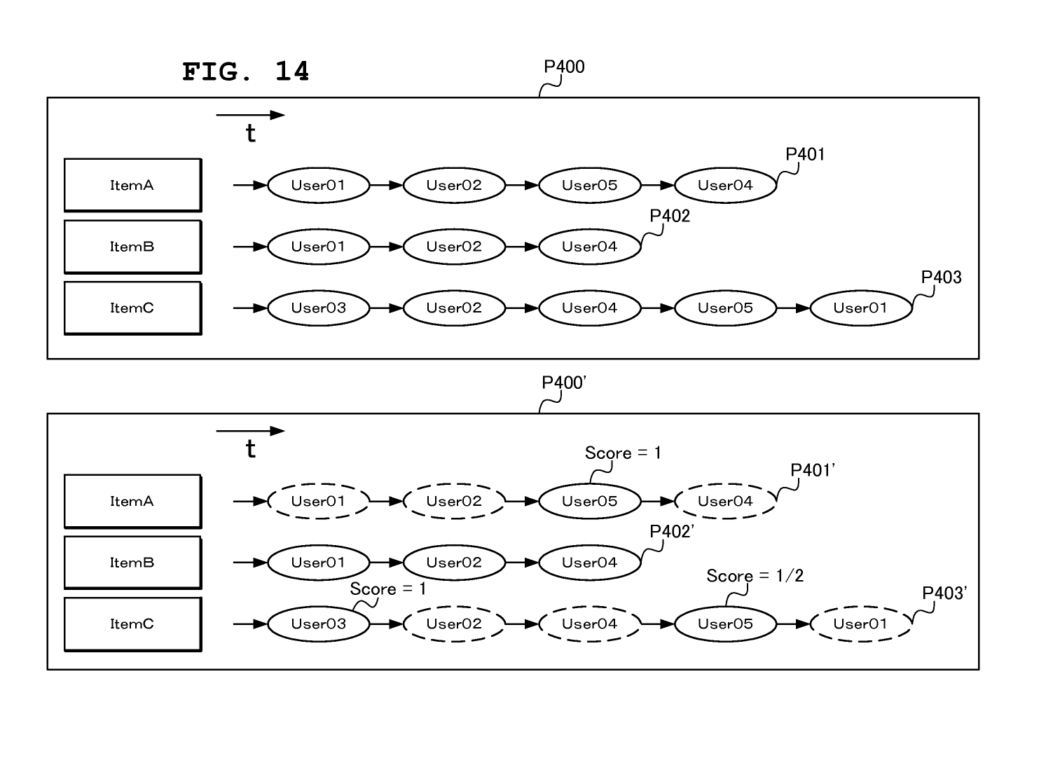

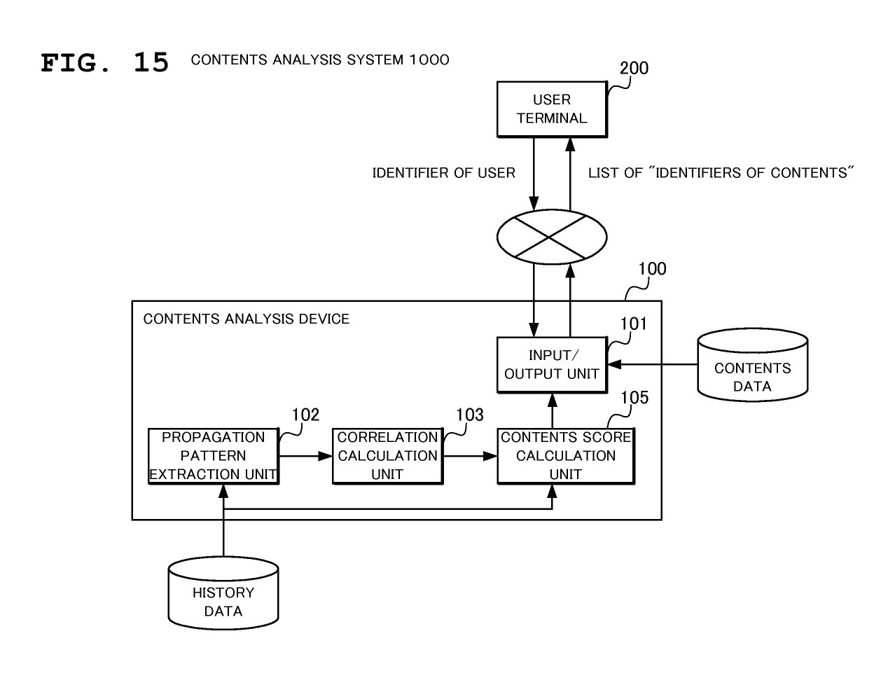

Next, the propagation pattern extraction unit 102 obtains history data to extract a pattern of propagation to users with respect to each content included in the history data similarly to the Example 1 (Step B2′). The present Example is assumed to have the order of propagation extracted as a propagation pattern. Example of the extraction results is shown in P400 in FIG. 14.

With reference to FIG. 14, in the present Example, patterns of propagation of Item B, Item A and Item C to users are extracted.

Next, the correlation calculation unit 103 obtains a correlation between propagation patterns of Item B and Item A, and Item B and Item C to users (Step B3′). The calculation method is the same as that of the Example 1.

Subsequently, the user score calculation unit 104 calculates a score of each user by using the pattern of propagation of each content to users which is calculated by the propagation pattern extraction unit 102 and the correlation between patterns of propagation to users which is calculated by the correlation calculation unit 103 (Step B4′).

The user score calculation unit 104 calculates to apply a higher score to a user to which content whose user propagation pattern is highly correlated with Item B propagates earlier.

More specifically, with respect to Item A, the user score calculation unit 104 first calculates to apply a score of a propagation order (propagation score) to other users than a user to which Item B propagated in ascending order of propagation. This applies also to Item C. As a propagation score, a reciprocal of the propagation order may be applied, for example.

Illustrative example of the above-described calculation is shown in P400′ in FIG. 14.

In P400′, to User 01, User 02 and User 04, Item B has propagated, so that excluding these users, User 05 comes fastest in propagation order as to Item A. As a result, the propagation score “1” is applied to User 05.

Similarly, as to Item C, the propagation score “1” is applied to User 03 and the propagation score “½” is applied to User 05.

Subsequently, the user score calculation unit 104 calculates a score of each user with respect to Item B by using the following Numerical Expression 2.

$$\begin{matrix}( NUMERICAL EXPRESSION 2 ) & \\ {[ \begin{matrix}{S}_{x , u} \text{:} SCORE OF USER u FOR CONTENT x \\ {S}_{y , u} \text{:} SCORE OF USER u FOR CONTENT y \\ \begin{matrix}{C}_{x , y} \text{:} COEFFICIENT OF CORRELATION BETWEEN \\ CONTENT x AND CONTENT y\end{matrix} \end{matrix} ]}^{{S}_{x , u} = \sum {S}_{y , u} * {C}_{x , y}} & \end{matrix}$$

Using the above-described Numerical Expression 2, a score of User 05 with respect to Item B, for example, will be a total sum of a product of a propagation score of User 05 related to Item A and a correlation between patterns of propagation of Item B and Item A to users, and a product of a propagation score of User 05 related to Item C and a correlation between patterns of propagation of Item B and Item C to users.

Similarly, after obtaining a score of each user with respect to Item B, the input/output unit 101 lastly returns the score of each user with respect to Item B to the user terminal 200 together with an identifier of the user (Step B5′). At this time, processing may be executed of sorting users' identifiers in descending order or ascending order of scores. Only a user's identifier may be returned.

Thus, calculating a score of a user with respect to certain content by using a correlation between patterns of propagation to users enables extraction of a group of users which is highly likely to have propagation earlier.

### Effects of the Second Exemplary Embodiment

Next, effects of the present exemplary embodiment will be described.

Since according to the present exemplary embodiment, the system is structured to calculate a score of a user with respect to arbitrary content, it is applicable to marketing analysis which examines and predicts a pattern of propagation of certain content, information recommendation which recommends contents at appropriate propagation timing, and the like.

### Third Exemplary Embodiment

Third exemplary embodiment of the present invention will be detailed with reference to the drawings. In the following drawings, no description will be made of a structure of a part not related to the gist of the present invention and no illustration will be accordingly made thereof.

FIG. 15 is a block diagram showing a structure of the contents analysis system 1000 according to the present exemplary embodiment.

With reference to FIG. 15, the contents analysis system 1000 according to the present exemplary embodiment is formed by the input/output unit 101, the propagation pattern extraction unit 102, the correlation calculation unit 103 and a contents score calculation unit 105. The present exemplary embodiment includes the contents score calculation unit 105 in addition to the components of the first exemplary embodiment.

In brief, these units each operate in the following manner.

The input/output unit 101 accepts a predetermined request from the user terminal 200 and returns an output corresponding to the request to the user terminal.

In the present exemplary embodiment, upon accepting an identifier of a user as an input, the unit returns a list of identifiers of contents recommendable to the user.

Similarly to the first and second exemplary embodiments, the propagation pattern extraction unit 102 extracts a pattern of propagation to users with respect to each content from history data.

The correlation calculation unit 103 obtains a correlation between propagations of the respective contents to users by using a pattern of propagation of each content to users.

The user score calculation unit 104 calculates a score of each user with respect to each content from a pattern of propagation of each content to users and a correlation between patterns of propagation of the respective contents to users.

The contents score calculation unit 105 calculates a score of content for each user from a correlation between patterns of propagation of the respective contents to users and each user's history of contents use. Only a score of each content for a user accepted as an input may be obtained. Specific method of calculating a score of content will be described later.

### Description of Operation of the Third Exemplary Embodiment

Next, operation of the contents analysis system according to the present exemplary embodiment will be detailed with reference to the drawings.

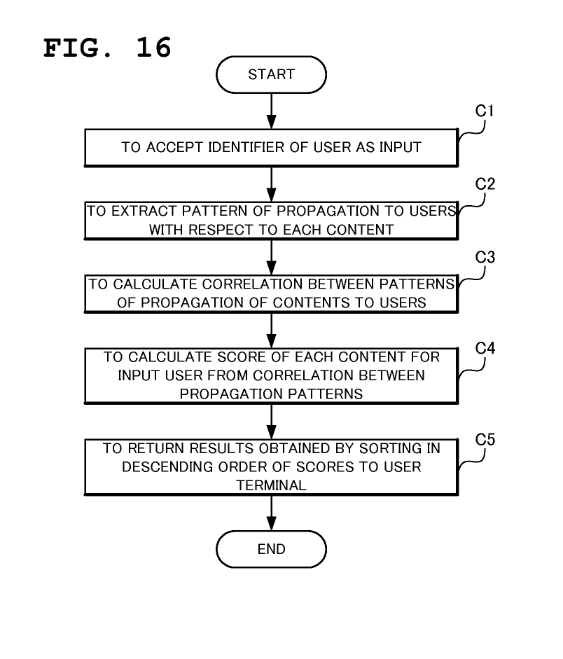

FIG. 16 is a flow chart showing operation of the contents analysis system 1000 according to the present exemplary embodiment.

With reference to FIG. 16, the input/output unit 101 first accepts an identifier of a user as an input from the user terminal 200 (C1).

Then, the propagation pattern extraction unit 102 obtains history data to extract a pattern of propagation to users with respect to each content included in the history data (Step C2).

Next, with respect to the respective contents in question, the correlation calculation unit 103 obtains a correlation between patterns of propagation of the contents to the users (Step C3). In the present exemplary embodiment, correlations are obtained with respect to all the combinations between the contents included in the history data.

After Step C3, the contents score calculation unit 105 subsequently uses the correlation obtained by the correlation calculation unit 103 and a history of use of each content by the user accepted as an input to calculate a score of each content for the user (Step C4).

Then, to the user accepted as an input, return identifiers of contents sorted in descending order of scores of the contents to the user terminal 200 (Step C5). Scores of the contents may be returned together.

### THIRD EXAMPLE

Next, operation of the present exemplary embodiment will be described with respect to a specific example.

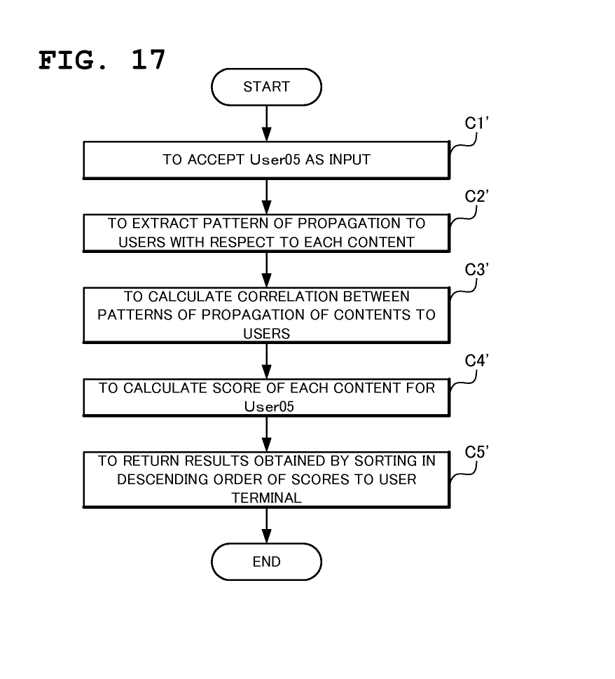

FIG. 17 is a flow chart showing operation of an Example 3 of the present invention.

With reference to FIG. 17, the input/output unit 101 first accepts User 05 (user identifier indicative of User 05) as an input from the user terminal 200 (Step C1′).

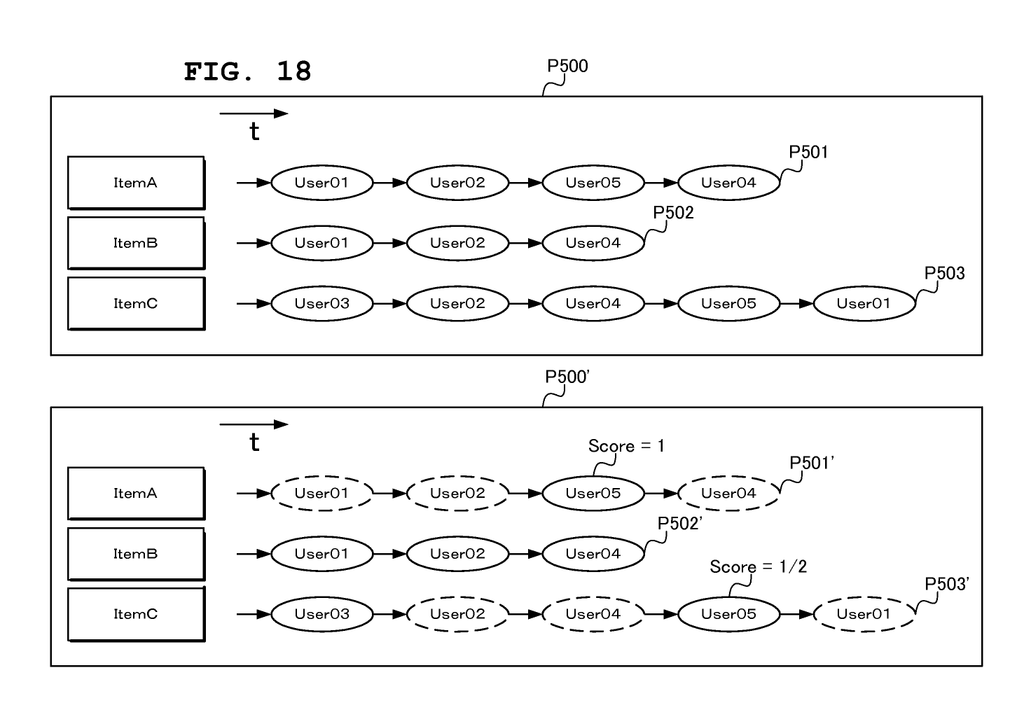

Next, the propagation pattern extraction unit 102 obtains history data to extract a pattern of propagation to users with respect to each content included in the history data similarly to the Example 1 (Step C2′). The present Example is also assumed to have a propagation order extracted as a propagation pattern similarly to the Example 2. Example of the extraction results is shown in P500 in FIG. 18.

With reference to FIG. 18, in the present Example, patterns of propagation of Item A, Item B and Item C to users are extracted.

Next, the correlation calculation unit 103 obtains a correlation between patterns of propagation of the respective contents to the users (Step C3′). More specifically, the correlation calculation unit 103 obtains a correlation between patterns of propagation of Item A and Item B, Item A and Item C, and Item B and Item C to the users.

The contents score calculation unit 105 subsequently calculates a score of each content for User 05 by using a pattern of propagation of each content to a user which is calculated by the propagation pattern extraction unit 102 and a correlation between patterns of propagation of the respective contents to users which is calculated by the correlation calculation unit 103 (Step C4′).

The contents score calculation unit 105 first calculates a score of content to apply a higher propagation score to content whose propagation to User 05 is early among the contents which has already propagated to User 05 and to which content whose propagation pattern is highly correlated to the content propagating to User 05.

Score of Item B for User 05 will be obtained by the following manner, for example.

First, the contents score calculation unit 105 calculates time of propagation of other contents to User 05 as a propagation score.

As to Item A, excluding users to which Item B has propagated, apply a propagation score of User 05. Also to Item C, similarly apply the propagation score of User 05. As a propagation score, a reciprocal of the propagation order may be applied, for example, similarly to the Example 2.

Illustrative example of the above-described calculation is shown in P500′ in FIG. 18.

In P500′, to User 01, User 02 and User 04, Item B has already propagated, so that excluding these users, User 05 comes fastest in propagation order as to Item A. As a result, the propagation score “1” is applied to User 05.

Similarly, as to Item C, the propagation order of User 05 is the second. As a result, the propagation score “½” is applied to User 05.

As described above, for obtaining a score of content of Item B for User 05, first obtain a propagation score of User 05 with respect to Item A and Item C as other contents. This is also the case with obtaining a score of content of Item A or Item C for User 05 although no description will be made thereof.

Then, when a propagation score of User 05 is obtained with respect to each of Item A and Item C, the contents score calculation unit 105 calculates a score of contents for User 05 by using the following Numerical Expression 3.

$$\begin{matrix}( NUMERICAL EXPRESSION 3 ) & \\ {[ \begin{matrix}{S}_{u , x} \text{:} SCORE OF CONTENT x FOR USER u \\ {S}_{u , y} \text{:} SCORE OF ALREADY PROPAGATING CONTENT y \\ FOR USER u \\ \begin{matrix}{C}_{x , y} \text{:} COEFFICIENT OF CORRELATION BETWEEN \\ CONTENT x AND CONTENT y\end{matrix} \end{matrix} ]}^{{S}_{u , x} = \sum {S}_{u , y} * {C}_{x , y}} & \end{matrix}$$

Using the above-described Numerical Expression 3, a score of Item B with respect to User 05, for example, will be a total sum of a product of a propagation score of User 05 related to Item A and a correlation between propagation scores of Item B and Item A to users, and a product of a propagation score of User 05 related to Item C and a correlation between propagation scores of Item B and Item C to users.

Similarly, after obtaining scores of Item A and Item B with respect to User 05, the input/output unit 101 lastly returns the identifiers of the respective contents sorted in descending order of scores of the contents to the user terminal 200 (Step C5′). At this time, the scores of the contents may be returned together.

Thus calculating a score of each content for a certain user by using a correlation between patterns of propagation to users enables extraction of a group of contents which is highly likely to propagate to the user in question earlier.

### Effects of the Third Exemplary Embodiment

Next, effects of the present exemplary embodiment will be described.

Since according to the present exemplary embodiment, the system is structured to recommend content to an arbitrary user based on a score of content calculated according to similarity of a propagation pattern, it is applicable to information recommendation of recommending appropriate contents to a certain user, and the like.

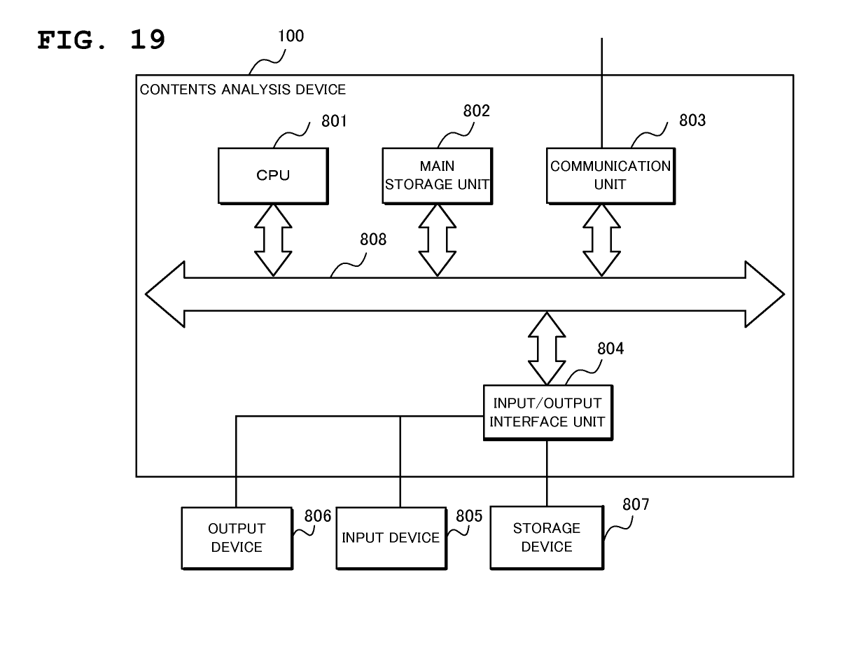

Next, an example of hardware configuration of the contents analysis device 100 of the present invention will be described with reference to FIG. 19. FIG. 19 is a block diagram showing an example of hardware configuration of the contents analysis device 100.

With reference to FIG. 19, the contents analysis device 100, which has the same hardware configuration as that of a common computer device, comprises a CPU (Central Processing Unit) 801, a main storage unit 802 formed of a memory such as a RAM (Random Access Memory) for use as a data working region or a data temporary saving region, a communication unit 803 which transmits and receives data through a network, an input/output interface unit 804 connected to an input device 805, an output device 806 and a storage device 807 to transmit and receive data, and a system bus 808 which connects each of the above-described components with each other. The storage device 807 is realized by a hard disk device or the like which is formed of a non-volatile memory such as a ROM (Read Only Memory), a magnetic disk or a semiconductor memory.

The input/output unit 101, the propagation pattern extraction unit 102, the correlation calculation unit 103, the user score calculation unit 104 and the contents score calculation unit 105 of the contents analysis device 100 of the present invention have their operation realized not only in hardware by mounting a circuit part as a hardware part such as an LSI (Large Scale Integration) with a program incorporated but also in software by storing a program which provides the function in the storage device 807, loading the program into the main storage unit 802 and executing the same by the CPU 801.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

An arbitrary combination of the foregoing components and conversion of the expressions of the present invention to/from a method, a device, a system, a recording medium, a computer program and the like are also available as a mode of the present invention.

In addition, the various components of the present invention need not always be independent from each other, and a plurality of components may be formed as one member, or one component may be formed by a plurality of members, or a certain component may be a part of other component, or a part of a certain component and a part of other component may overlap with each other, or the like.

While the method and the computer program of the present invention have a plurality of procedures recited in order, the order of recitation is not a limitation to the order of execution of the plurality of procedures. When executing the method and the computer program of the present invention, therefore, the order of execution of the plurality of procedures can be changed without hindering the contents.

Moreover, execution of the plurality of procedures of the method and the computer program of the present invention are not limitedly executed at timing different from each other. Therefore, during the execution of a certain procedure, other procedure may occur, or a part or all of execution timing of a certain procedure and execution timing of other procedure may overlap with each other, or the like.

Furthermore, a part or all of the above-described exemplary embodiments can be recited as the following claims but are not to be construed limitative.

The whole or part of the exemplary embodiments disclosed above can be described as, but not limited to, the following supplementary notes.

(Supplementary note 1.) 1. A contents analysis system, comprising:

a user terminal; and

a contents analysis device which receives a predetermined request from said user terminal and returns a result,

wherein said contents analysis device comprises

a propagation pattern extraction unit which extracts a pattern of propagation indicating, with respect to each of contents included in history data formed of histories of use of a plurality of contents, how the content propagated to a user, and

a correlation calculation unit which obtains a correlation between said patterns of propagation of said contents.

(Supplementary note 2.) The contents analysis system according to supplementary note 1, wherein said history data includes at least time and date of use, a user and an identifier of content used.

(Supplementary note 3.) The contents analysis system according to supplementary note 1 or supplementary note 2, wherein said propagation pattern extraction unit extracts, in time series, an order of propagation of each content to users as said pattern of propagation.

(Supplementary note 4.) The contents analysis system according to supplementary note 1 or supplementary note 2, wherein with respect to each content, said propagation pattern extraction unit extracts a group of users to which the content propagated as said pattern of propagation, the group being classified into a plurality of stages based on a propagation order.

(Supplementary note 5. The contents analysis system according to supplementary note 1 or supplementary note 2, wherein with respect to each content, said propagation pattern extraction unit extracts a network structure of a user to which the content propagated as said pattern of propagation.

(Supplementary note 6.) The contents analysis system according to any one of claim 1 to claim 5, wherein said correlation calculation unit obtains, with respect to input content accepted from said user terminal as an input, a correlation between said pattern of propagation of the input content and said pattern of propagation of other said each content.

(Supplementary note 7.) The contents analysis system according to any one of supplementary note 1 to supplementary note 5, further comprising a user score calculation unit which, with respect to input content accepted from said user terminal as an input, calculates a user score indicative of a possibility of propagation of the input content for a user to which said input content is yet to propagate by using said pattern of propagation of said each content and a correlation between said patterns of propagation of said contents.

(Supplementary note 8.) The contents analysis system according to supplementary note 7, wherein said user score calculation unit calculates, with respect to a user not included in said pattern of propagation of said input content, a propagation score of the user related to other content, takes a value of a product of said propagation score and a correlation between said patterns of propagation of said input content and said other content as said user score and when said other content includes a plurality of contents, takes a value of a total sum of products as said user score, and calculates said propagation score based on an order of propagation in a propagation pattern of said other content excluding a user included in the propagation pattern of said input content.

(Supplementary note 9.) The contents analysis system according to any one of supplementary note 1 to supplementary note 5, further comprising a contents score calculation unit which calculates a contents score indicative of the degree of recommendableness to an input user accepted as an input from said user terminal with respect to each content which is yet to propagate to said input user by using said pattern of propagation of said each content and a correlation between said patterns of propagation of said contents.

(Supplementary note 10.) The contents analysis system according to supplementary note 9, wherein said contents score calculation unit

calculates, with respect to content yet to propagate to said input user, a propagation score of the input user related to other content, takes a value of a product of said propagation score and a correlation with said pattern of propagation of said other content as said contents score and when said other content includes a plurality of contents, takes a value of a total sum of the products as said contents score, and

calculates said propagation score based on an order of propagation in a propagation pattern of said other content excluding a user included in said pattern of propagation of content yet to propagate to said input user.

(Supplementary note 11.) A contents analysis device which receives a predetermined request from a user terminal and returns a result, comprising:

a propagation pattern extraction unit which extracts a pattern of propagation indicating, with respect to each of contents included in history data formed of histories of use of a plurality of contents, how the content propagated to a user; and

a correlation calculation unit which obtains a correlation between said patterns of propagation of said contents.

(Supplementary note 12.) The contents analysis device according to supplementary note 11, wherein said history data includes at least time and date of use, a user and an identifier of content used.

(Supplementary note 13.) The contents analysis device according to supplementary note 11 or supplementary note 12, wherein said propagation pattern extraction unit extracts, in time series, an order of propagation of each content to users as said pattern of propagation.

(Supplementary note 14.) The contents analysis device according to supplementary note 11 or supplementary note 12, wherein with respect to each content, said propagation pattern extraction unit extracts a group of users to which the content propagated as said pattern of propagation, the group being classified into a plurality of stages based on a propagation order.

(Supplementary note 15.) The contents analysis device according to supplementary note 11 or supplementary note 12, wherein with respect to each content, said propagation pattern extraction unit extracts a network structure of a user to which the content propagated as said pattern of propagation.

(Supplementary note 16.) The contents analysis device according to any one of claim 11 to claim 15, wherein said correlation calculation unit obtains, with respect to input content accepted from said user terminal as an input, a correlation between said pattern of propagation of the input content and said pattern of propagation of other said each content.

(Supplementary note 17.) The contents analysis device according to any one of supplementary note 11 to supplementary note 15, further comprising a user score calculation unit which, with respect to input content accepted from said user terminal as an input, calculates a user score indicative of a possibility of propagation of the input content for a user to which said input content is yet to propagate by using said pattern of propagation of said each content and a correlation between said patterns of propagation of said contents.

(Supplementary note 18.) The contents analysis device according to supplementary note 17, wherein said user score calculation unit

calculates, with respect to a user not included in said pattern of propagation of said input content, a propagation score of the user related to other content, takes a value of a product of said propagation score and a correlation between said patterns of propagation of said input content and said other content as said user score and when said other content includes a plurality of contents, takes a value of a total sum of products as said user score, and

calculates said propagation score based on an order of propagation in a propagation pattern of said other content excluding a user included in the propagation pattern of said input content.

(Supplementary note 19.) The contents analysis device according to any one of supplementary note 11 to supplementary note 15, further comprising a contents score calculation unit which calculates a contents score indicative of the degree of recommendableness to an input user accepted as an input from said user terminal with respect to each content which is yet to propagate to said input user by using said pattern of propagation of said each content and a correlation between said patterns of propagation of said contents.

(Supplementary note 20.) The contents analysis device according to supplementary note 19, wherein said contents score calculation unit

calculates, with respect to content yet to propagate to said input user, a propagation score of the input user related to other content, takes a value of a product of said propagation score and a correlation with said pattern of propagation of said other content as said contents score and when said other content includes a plurality of contents, takes a value of a total sum of the products as said contents score, and

calculates said propagation score based on an order of propagation in a propagation pattern of said other content excluding a user included in said pattern of propagation of content yet to propagate to said input user.

(Supplementary note 21.) A contents analysis method of a contents analysis device which receives a predetermined request from a user terminal and returns a result, comprising:

a propagation pattern extraction step of extracting a pattern of propagation indicating, with respect to each of contents included in history data formed of histories of use of a plurality of contents, how the content propagated to a user; and

a correlation calculation step of obtaining a correlation between said patterns of propagation of said contents.

(Supplementary note 22.) The contents analysis method according to supplementary note 21, wherein said history data includes at least time and date of use, a user and an identifier of content used.

(Supplementary note 23.) The contents analysis method according to supplementary note 21 or supplementary note 22, wherein said propagation pattern extraction step includes extracting, in time series, an order of propagation of each content to users as said pattern of propagation.

(Supplementary note 24.) The contents analysis method according to supplementary note 21 or supplementary note 22, wherein with respect to each content, said propagation pattern extraction step includes extracting a group of users to which the content propagated as said pattern of propagation, the group being classified into a plurality of stages based on a propagation order.

(Supplementary note 25. The contents analysis method according to supplementary note 21 or supplementary note 22, wherein with respect to each content, said propagation pattern extraction step includes extracting a network structure of a user to which the content propagated as said pattern of propagation.

(Supplementary note 26.) The contents analysis method according to any one of claim 21 to claim 25, wherein said correlation calculation step includes obtaining, with respect to input content accepted from said user terminal as an input, a correlation between said pattern of propagation of the input content and said pattern of propagation of other said each content.

(Supplementary note 27.) The contents analysis method according to any one of supplementary note 21 to supplementary note 25, further comprising the user score calculation step of, with respect to input content accepted from said user terminal as an input, calculating a user score indicative of a possibility of propagation of the input content for a user to which said input content is yet to propagate by using said pattern of propagation of said each content and a correlation between said patterns of propagation of said contents.

(Supplementary note 28.) The contents analysis method according to supplementary note 27, wherein said user score calculation step includes

calculating, with respect to a user not included in said pattern of propagation of said input content, a propagation score of the user related to other content, taking a value of a product of said propagation score and a correlation between said patterns of propagation of said input content and said other content as said user score and when said other content includes a plurality of contents, taking a value of a total sum of products as said user score, and

calculating said propagation score based on an order of propagation in a propagation pattern of said other content excluding a user included in the propagation pattern of said input content.

(Supplementary note 29.) The contents analysis method according to any one of supplementary note 21 to supplementary note 25, further comprising the contents score calculation step of calculating a contents score indicative of the degree of recommendableness to an input user accepted as an input from said user terminal with respect to each content which is yet to propagate to said input user by using said pattern of propagation of said each content and a correlation between said patterns of propagation of said contents.

(Supplementary note 30.) The contents analysis method according to supplementary note 29, wherein said contents score calculation step includes

calculating, with respect to content yet to propagate to said input user, a propagation score of the input user related to other content, taking a value of a product of said propagation score and a correlation with said pattern of propagation of said other content as said contents score and when said other content includes a plurality of contents, taking a value of a total sum of the products as said contents score, and

calculating said propagation score based on an order of propagation in a propagation pattern of said other content excluding a user included in said pattern of propagation of content yet to propagate to said input user.

(Supplementary note 31.) A contents analysis program operable on a computer functioning as a contents analysis device which receives a predetermined request from a user terminal and returns a result, which causes said computer to execute:

a propagation pattern extraction processing of extracting a pattern of propagation indicating, with respect to each of contents included in history data formed of histories of use of a plurality of contents, how the content propagated to a user; and

a correlation calculation processing of obtaining a correlation between said patterns of propagation of said contents.

(Supplementary note 32.) The contents analysis program according to supplementary note 31, wherein said history data includes at least time and date of use, a user and an identifier of content used.

(Supplementary note 33.) The contents analysis program according to supplementary note 31 or supplementary note 32, wherein said propagation pattern extraction processing includes extracting, in time series, an order of propagation of each content to users as said pattern of propagation.

(Supplementary note 34.) The contents analysis program according to supplementary note 31 or supplementary note 32, wherein with respect to each content, said propagation pattern extraction processing includes extracting a group of users to which the content propagated as said pattern of propagation, the group being classified into a plurality of stages based on a propagation order.

(Supplementary note 35.) The contents analysis program according to supplementary note 31 or supplementary note 32, wherein with respect to each content, said propagation pattern extraction processing includes extracting a network structure of a user to which the content propagated as said pattern of propagation.

(Supplementary note 36.) The contents analysis program according to any one of claim 31 to claim 35, wherein said correlation calculation processing includes obtaining, with respect to input content accepted from said user terminal as an input, a correlation between said pattern of propagation of the input content and said pattern of propagation of other said each content.

(Supplementary note 37.) The contents analysis program according to any one of supplementary note 31 to supplementary note 35, which further causes said computer to execute the user score calculation processing of, with respect to input content accepted from said user terminal as an input, calculating a user score indicative of a possibility of propagation of the input content for a user to which said input content is yet to propagate by using said pattern of propagation of said each content and a correlation between said patterns of propagation of said contents.

(Supplementary note 38.) The contents analysis program according to supplementary note 37, wherein said user score calculation processing includes

calculating, with respect to a user not included in said pattern of propagation of said input content, a propagation score of the user related to other content, taking a value of a product of said propagation score and a correlation between said patterns of propagation of said input content and said other content as said user score and when said other content includes a plurality of contents, taking a value of a total sum of products as said user score, and

calculating said propagation score based on an order of propagation in a propagation pattern of said other content excluding a user included in the propagation pattern of said input content.

(Supplementary note 39.) The contents analysis program according to any one of supplementary note 31 to supplementary note 35, which further causes said computer to execute the contents score calculation processing of calculating a contents score indicative of the degree of recommendableness to an input user accepted as an input from said user terminal with respect to each content which is yet to propagate to said input user by using said pattern of propagation of said each content and a correlation between said patterns of propagation of said contents.

(Supplementary note 40.) The contents analysis program according to supplementary note 39, wherein said contents score calculation processing includes

calculating, with respect to content yet to propagate to said input user, a propagation score of the input user related to other content, taking a value of a product of said propagation score and a correlation with said pattern of propagation of said other content as said contents score and when said other content includes a plurality of contents, taking a value of a total sum of the products as said contents score, and

calculating said propagation score based on an order of propagation in a propagation pattern of said other content excluding a user included in said pattern of propagation of content yet to propagate to said input user.

### INCORPORATION BY REFERENCE

This application is based upon and claims the benefit of priority from Japanese patent application No. 2010-264735, filed on Nov. 29, 2010, the disclosure of which is incorporated herein in its entirety by reference.

### INDUSTRIAL APPLICABILITY

The present invention is applicable to marketing analysis of analyzing a propagation pattern of certain content or to other use. It is also applicable to such use as information recommendation by using a correlation between propagation patterns of certain content.

1. A contents analysis system, comprising:
a user terminal; and
a contents analysis device which receives a predetermined request from said user terminal and returns a result,
wherein said contents analysis device comprises
a propagation pattern extraction unit which extracts a pattern of propagation indicating, with respect to each of contents included in history data formed of histories of use of a plurality of contents, how the content propagated to a user, and
a correlation calculation unit which obtains a correlation between said patterns of propagation of said contents.

2. The contents analysis system according to claim 1, wherein said history data includes at least time and date of use, a user and an identifier of content used.

3. The contents analysis system according to claim 1, wherein said propagation pattern extraction unit extracts, in time series, an order of propagation of each content to users as said pattern of propagation.

4. The contents analysis system according to claim 1, wherein with respect to each content, said propagation pattern extraction unit extracts a group of users to which the content propagated as said pattern of propagation, the group being classified into a plurality of stages based on a propagation order.

5. The contents analysis system according to claim 1, wherein with respect to each content, said propagation pattern extraction unit extracts a network structure of a user to which the content propagated as said pattern of propagation.

6. The contents analysis system according to claim 1, further comprising a user score calculation unit which, with respect to input content accepted from said user terminal as an input, calculates a user score indicative of a possibility of propagation of the input content for a user to which said input content is yet to propagate by using said pattern of propagation of said each content and a correlation between said patterns of propagation of said contents.

7. The contents analysis system according to claim 1, further comprising a contents score calculation unit which calculates a contents score indicative of the degree of recommendableness to an input user accepted as an input from said user terminal with respect to each content which is yet to propagate to said input user by using said pattern of propagation of said each content and a correlation between said patterns of propagation of said contents.

8. A contents analysis device which receives a predetermined request from a user terminal and returns a result, comprising:
a propagation pattern extraction unit which extracts a pattern of propagation indicating, with respect to each of contents included in history data formed of histories of use of a plurality of contents, how the content propagated to a user; and
a correlation calculation unit which obtains a correlation between said patterns of propagation of said contents.

9. A contents analysis method of a contents analysis device which receives a predetermined request from a user terminal and returns a result, comprising:
a propagation pattern extraction step of extracting a pattern of propagation indicating, with respect to each of contents included in history data formed of histories of use of a plurality of contents, how the content propagated to a user; and
a correlation calculation step of obtaining a correlation between said patterns of propagation of said contents.

10. A computer-readable medium storing a contents analysis program operable on a computer functioning as a contents analysis device which receives a predetermined request from a user terminal and returns a result, wherein said contents analysis program causes said computer to execute:
a propagation pattern extraction processing of extracting a pattern of propagation indicating, with respect to each of contents included in history data formed of histories of use of a plurality of contents, how the content propagated to a user; and
a correlation calculation processing of obtaining a correlation between said patterns of propagation of said contents.
